(19) United States
(12) Patent Application Publication
(10) Pub. No.: US 2024/0294090 A1
(43) Pub. Date: Sep. 5, 2024

(54) SERVER DEVICE

(71) Applicant: TOYOTA JIDOSHA KABUSHIKI KAISHA, Toyota-shi (JP)

(72) Inventors: Takahiro AOKI, Saitama-shi (JP); Yuta TAKATA, Toyota-shi (JP); Haruki OGURI, Toyota-shi (JP); Takashi YAMAZAKI, Nagoya-shi (JP); Tsuyoshi OKADA, Nagoya-shi (JP); Hiroki ASAO, Kobe-shi (JP)

(73) Assignee: TOYOTA JIDOSHA KABUSHIKI KAISHA, Toyota-shi (JP)

(21) Appl. No.: 18/405,054

(22) Filed: Jan. 5, 2024

(30) Foreign Application Priority Data
Mar. 2, 2023 (JP) 2023-032240

(51) Int. Cl. B60L 53/68; B60L 53/62

(52) U.S. Cl. CPC B60L 53/68; B60L 53/62

(57) ABSTRACT

The server device includes a communication unit and a control unit that performs communication using the communication unit, and the control unit determines the remaining battery level based on information about the user's travel schedule and the remaining battery capacity of the user's vehicle. A point and time at which a predetermined state will occur is predicted, and information proposing dispatch of a power supply vehicle to the point is sent to the user's terminal device at the time, prompting the user to decide on the dispatch.

### CROSS-REFERENCE TO RELATED APPLICATION

This application claims priority to Japanese Patent Application No. 2023-032240 filed on Mar. 2, 2023, incorporated herein by reference in its entirety.

### BACKGROUND

### 1. Technical Field

The present disclosure relates to a server device.

### 2. Description of Related Art

A battery electric vehicle (electric vehicle or EV) etc. driven by a battery may run out of power, that is, may run out of battery, while moving. Various techniques have been proposed to eliminate or avoid such a situation. For example, Japanese Unexamined Patent Application Publication No. 2019-093968 (JP 2019-093968 A) discloses a technique of charging a vehicle running out of battery from another vehicle.

### SUMMARY

When a user of an EV or the like receives a dispatch of a power supply vehicle, there is room for improving convenience of the user.

The present disclosure provides a server device or the like that is able to improve convenience of a user who receives a dispatch of a power supply vehicle.

A server device according to the present disclosure includes: a communication unit; and
a control unit that performs communication using the communication unit.

The control unit predicts, based on a movement schedule of a user and information on a remaining battery capacity of a vehicle of the user, a point and time at which the remaining battery capacity reaches a predetermined state.

Information proposing a dispatch of a power supply vehicle to the point at the time is transmitted to a terminal device of the user to prompt the user to decide on the dispatch.

With the server device or the like according to the present disclosure, it is possible to improve the convenience of the user who receives the dispatch of the power supply vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of the configuration of a vehicle management system; and

FIG. 2 is a diagram illustrating an example of the operation procedure of the server device, the power supply vehicle, and the terminal device.

### DETAILED DESCRIPTION OF EMBODIMENTS

Embodiments will be described below with reference to the drawings.

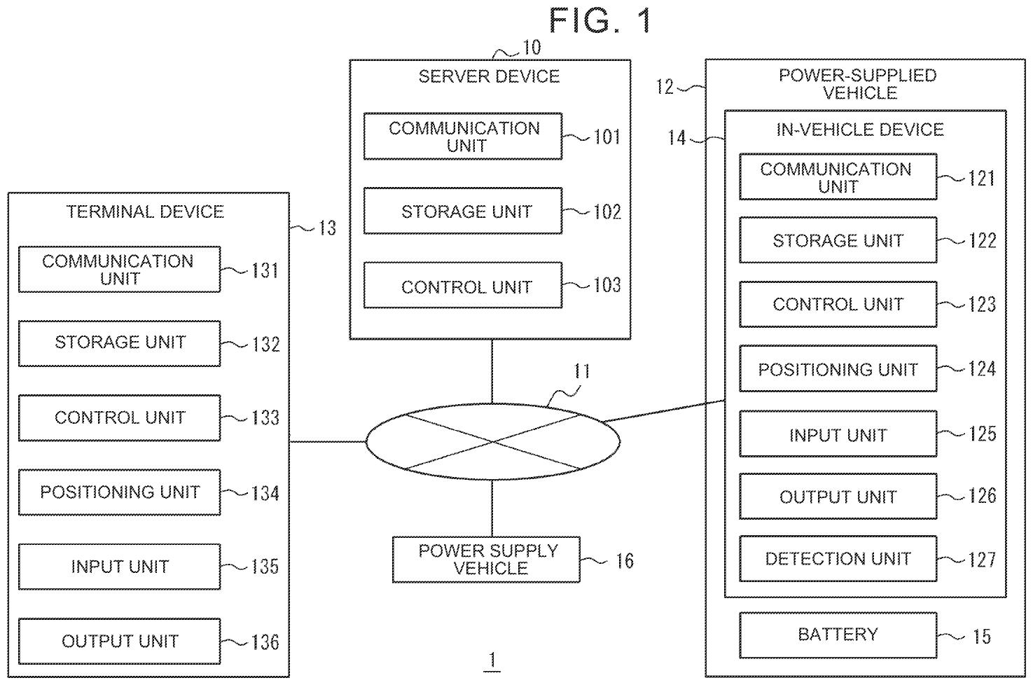

FIG. 1 is a diagram showing a configuration example of a vehicle management system in one embodiment. The vehicle management system 1 includes one or more server devices 10, power-supplied vehicles 12, terminal devices 13, and power supply vehicles 16, each of which is connected to each other via a network 11 so as to be able to communicate information.

The server device 10 is, for example, a server computer belonging to a cloud computing system or other computing systems and functioning as a server implemented with various functions.

The power-supplied vehicle 12 is a passenger car or a commercial vehicle equipped with a communication function and an information processing function, and is connected to the network 11 via a mobile communication network. The power-supplied vehicle 12 is, for example, a battery electric vehicle (BEV), a hybrid electric vehicle (HEV), a plug-in hybrid electric vehicle (PHEV), or the like, which is driven by electric power from a mounted battery 15. In this embodiment, the power-supplied vehicle 12 receives power at a power supply station or receives power from the power supply vehicle 16 when power supply is required. The power-supplied vehicle 12 may be driven by a driver, or may be driven to any level of automation.

The terminal device 13 is an information processing device equipped with a communication function, and is used by the user of the power-supplied vehicle 12 to perform various information communication and information processing. The terminal device 13 is, for example, an information processing terminal such as a smartphone, a tablet terminal, or a personal computer. The terminal device 13 may be configured as part or all of the in-vehicle device 14 mounted on the power-supplied vehicle 12.

The power supply vehicle 16 is a passenger car or a commercial vehicle equipped with a communication function and an information processing function, and is connected to the network 11 via a mobile communication network. Power supply vehicle 16 has the same configuration as power-supplied vehicle 12, but battery 15 in power supply vehicle 16 includes a battery that stores electric power for supplying power to power-supplied vehicle 12. The power supply vehicle 16 is, for example, a gasoline vehicle, a fuel cell electric vehicle (FCEV), or a BEV, HEV, PHEV, etc. that is driven by electric power from the battery 15 mounted thereon. The power supply vehicle 16 may be driven by a driver, or may be driven at any level of automation.

Network 11 is, for example, the Internet, but also includes ad hoc networks, LANs, Metropolitan Area Networks (MANs), and/or other networks.

In the present embodiment, the vehicle management system 1 is a system for supporting the power supply vehicle 16 to charge the power-supplied vehicle 12 when the power-supplied vehicle 12 falls into a power shortage state. The power shortage state is a state in which the remaining battery power is less than an arbitrary remaining power. The arbitrary remaining amount may be a remaining amount arbitrarily set in advance, or may be a remaining amount derived in advance through experiments etc. to the extent that one or more operations including driving the motor of the power supply vehicle 16 cannot be executed. It's okay. Furthermore, the power shortage state may be a state in which the user of the power-supplied vehicle 12 arbitrarily determines that power supply is necessary. Rush charging is a mode in which power is supplied by moving the power supply vehicle 16 to the position of the power-supplied vehicle 12 and charging the battery 15 of the power-supplied vehicle 12 from the battery 15 of the power supply vehicle 16. In the vehicle management system 1, the server device 10 performs a process for dispatching a power supply vehicle 16 to each of one or more power-supplied vehicles 12 to perform on-call charging.

The server device 10 includes a communication unit 101 and a control unit 103 that performs communication using the communication unit 101. The control unit 103 predicts the point and time at which the remaining battery level will reach a predetermined state, that is, the power shortage state, based on the travel schedule of the user of the power-supplied vehicle 12 and the remaining battery level of the power-supplied vehicle 12 (hereinafter referred to as, the predicted point and time will be referred to as a predicted point and predicted time, respectively), and information proposing dispatch of the power supply vehicle 16 to the predicted point at the predicted time is sent to the user's terminal device 13 to prompt the user to decide on dispatch. If the user wishes to dispatch the power supply vehicle 16, he or she can send an instruction to determine dispatch to the server device 10 using the terminal device 13, so a plan for receiving power supply at the predicted time and predicted location can be created in advance. Therefore, the user does not need to pay attention to the timing of receiving power supply while moving in the power-supplied vehicle 12. Therefore, user convenience can be improved.

Next, a configuration example of the server device 10, the power-supplied vehicle 12, and the terminal device 13 will be described.

The server device 10 includes a communication unit 101, a storage unit 102, and a control unit 103. The server device 10 may be one computer, or may be composed of two or more computers that are connected to enable information communication and operate in coordination. When the server device 10 is composed of two or more computers, the configuration shown in FIG. 1 is appropriately arranged on the two or more computers.

Communication unit 101 includes one or more communication interfaces. The communication interface is, for example, a LAN interface. The communication unit 101 receives information used for the operation of the control unit 103 and transmits information obtained by the operation of the control unit 103. The server device 10 is connected to the network 11 by a communication unit 101 and performs information communication with the power-supplied vehicle 12 and the terminal device 13 via the network 11.

The storage unit 102 includes, for example, one or more semiconductor memories, one or more magnetic memories, one or more optical memories, or a combination of at least two of these, which function as a main storage device, an auxiliary storage device, or a cache memory. The semiconductor memory is, for example, Random Access Memory (RAM) or Read Only Memory (ROM). The RAM is, for example, Static RAM (SRAM) or Dynamic RAM (DRAM). The ROM is, for example, an Electrically Erasable Programmable ROM (EEPROM). The storage unit 102 stores information used for the operation of the control unit 103 and information obtained by the operation of the control unit 103.

Control unit 103 includes one or more processors, one or more dedicated circuits, or a combination thereof. The processor is, for example, a general-purpose processor such as a Central Processing Unit (CPU), or a dedicated processor such as a Graphics Processing Unit (GPU) specialized for specific processing. The dedicated circuit is, for example, a Field-Programmable Gate Array (FPGA), an Application Specific Integrated Circuit (ASIC), or the like. The control unit 103 executes information processing related to the operation of the server device 10 while controlling each part of the server device 10.

The functions of the server device 10 are realized by executing a control program by a processor included in the control unit 103. The control program is a program that causes the computer to execute the processing of steps included in the operation of the server device 10, thereby causing the computer to realize functions corresponding to the processing of the steps. That is, the control program is a program for causing the computer to function as the server device 10. Furthermore, some or all of the functions of the server device 10 may be realized by a dedicated circuit included in the control unit 103. Further, the control program may be stored in a non-transitory recording/storage medium that can be read by the server device 10, and the server device 10 may read the control program from the medium.

Power-supplied vehicle 12 includes an in-vehicle device 14 and a battery 15. The in-vehicle device 14 includes a communication unit 121, a storage unit 122, a control unit 123, a positioning unit 124, an input unit 125, an output unit 126, and a detection unit 127. One or more of these parts may be configured as one control device, or may be configured by the terminal device 13, a navigation device, etc. Alternatively, each part may be connected to enable information communication via an in-vehicle network compliant with standards such as Controller Area Network (CAN). The battery 15 is, for example, one or more lithium-ion batteries that charge and discharge electric power for driving the power-supplied vehicle 12.

The communication unit 121 includes one or more communication interfaces. The communication interface is, for example, an interface compatible with mobile communication standards such as Long Term Evolution (LTE), 4th Generation (4G), or 5th Generation (5G). The communication unit 121 receives information used for the operation of the control unit 123 and transmits information obtained by the operation of the control unit 123. The control unit 123 is connected to the network 11 via a mobile communication base station by the communication unit 121, and performs information communication with the server device 10 and the like via the network 11.

The storage unit 122 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 122 functions as, for example, a main storage device, an auxiliary storage device, or a cache memory. The storage unit 122 stores information used for the operation of the control unit 123 and information obtained by the operation of the control unit 123.

Control unit 123 includes one or more processors, one or more dedicated circuits, or a combination thereof. The processor is a general-purpose processor such as a CPU or a dedicated processor specialized for specific processing. The dedicated circuit is, for example, an FPGA or an ASIC. The control unit 123 executes information processing related to the operation of the power-supplied vehicle 12 while controlling each unit of the in-vehicle device 14.

The positioning unit 124 includes one or more Global Navigation Satellite System (GNSS) receivers. GNSS includes, for example, at least one of Global Positioning System (GPS), Quasi-Zenith Satellite System (QZSS), BeiDou, Global Navigation Satellite System (GLONASS), and Galileo. The positioning unit 124 sends the positioning result to the control unit 123, and the control unit 123 determines the position information of the power-supplied vehicle 12.

The input unit 125 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. The input unit 125 accepts an operation to input information used for the operation of the control unit 123 and sends the input information to the control unit 123.

The output unit 126 includes one or more output interfaces. The output interface is, for example, a display or a speaker. The display is, for example, a Liquid Crystal Display (LCD) or an Electro-Luminescence (organic EL) display. The output unit 126 outputs information obtained by the operation of the control unit 123.

The detection unit 127 has an interface with one or more sensors that detects the state of each part of the power-supplied vehicle 12, or one or more sensors. The sensors include, for example, a sensor that detects the remaining battery level of the battery 15, a sensor that detects the motion state (speed, longitudinal acceleration, lateral acceleration, deceleration, etc.) of the power-supplied vehicle 12, and the like. The detection unit 127 sends information indicating each state detected by the sensor to the control unit 123.

The functions of the control unit 123 are realized by executing a control program with a processor included in the control unit 123. The control program is a program that causes the computer to execute the processing of the steps included in the operation of the control unit 123, thereby causing the computer to realize a function corresponding to the processing of the steps. That is, the control program is a program for causing the computer to function as the control unit 123. Further, some or all of the functions of the control unit 123 may be realized by a dedicated circuit included in the control unit 123.

The power supply vehicle 16 has the same configuration as the power-supplied vehicle 12, and the above description of each part of the power-supplied vehicle 12 applies to the power supply vehicle 16. However, the battery 15 of the power supply vehicle 16 includes a battery that charges and discharges power to be supplied to the power-supplied vehicle 12.

The terminal device 13 is, for example, an information processing device such as a smartphone or a tablet terminal, or an information processing device that constitutes part or all of an in-vehicle device mounted on the power-supplied vehicle 12. The terminal device 13 includes a communication unit 131, a storage unit 132, a control unit 133, a positioning unit 134, an input unit 135, and an output unit 136.

The communication unit 131 includes a communication module compatible with wired or wireless LAN standards, a module compatible with mobile communication standards such as LTE, 4G, or 5G. The terminal device 13 is connected to the network 11 by a communication unit 131 via a nearby router device or a mobile communication base station, and performs information communication with the server device 10 and the like via the network 11.

The storage unit 132 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 132 functions as, for example, a main storage device, an auxiliary storage device, or a cache memory. The storage unit 132 stores information used for the operation of the control unit 133 and information obtained by the operation of the control unit 133.

The control unit 133 includes, for example, one or more general-purpose processors such as a CPU or a Micro Processing Unit (MPU), or one or more dedicated processors specialized for specific processing. Alternatively, the control unit 133 may include one or more dedicated circuits such as FPGA or ASIC. The control unit 133 comprehensively controls the operation of the terminal device 13 by operating according to a control/processing program or according to an operation procedure implemented as a circuit. The control unit 133 transmits and receives various information to and from the server device 10 and the like via the communication unit 131, and executes operations according to the present embodiment.

The positioning unit 134 includes one or more GNSS receivers. The GNSS includes, for example, at least one of GPS, QZSS, BeiDou, GLONASS, and Galileo. The positioning unit 134 sends the positioning result to the control unit 133, and the control unit 133 determines the position information of the terminal device 13.

The input unit 135 includes one or more input interfaces. The input interface is, for example, a physical key, a capacitive key, a pointing device, a touch screen integrated with a display, or a microphone that receives voice input. The input interface may further include a camera that captures images or image codes, or an IC card reader. The input unit 135 accepts an operation to input information used for the operation of the control unit 133 and sends the input information to the control unit 133.

The output unit 136 includes one or more output interfaces. The output interface is, for example, a display or a speaker. The display is, for example, an LCD or an organic EL display. The output unit 136 outputs information obtained by the operation of the control unit 133.

The functions of the control unit 133 are realized by a processor included in the control unit 133 executing a control program. The control program is a program for causing the processor to function as the control unit 133. Further, some or all of the functions of the control unit 133 may be realized by a dedicated circuit included in the control unit 133.

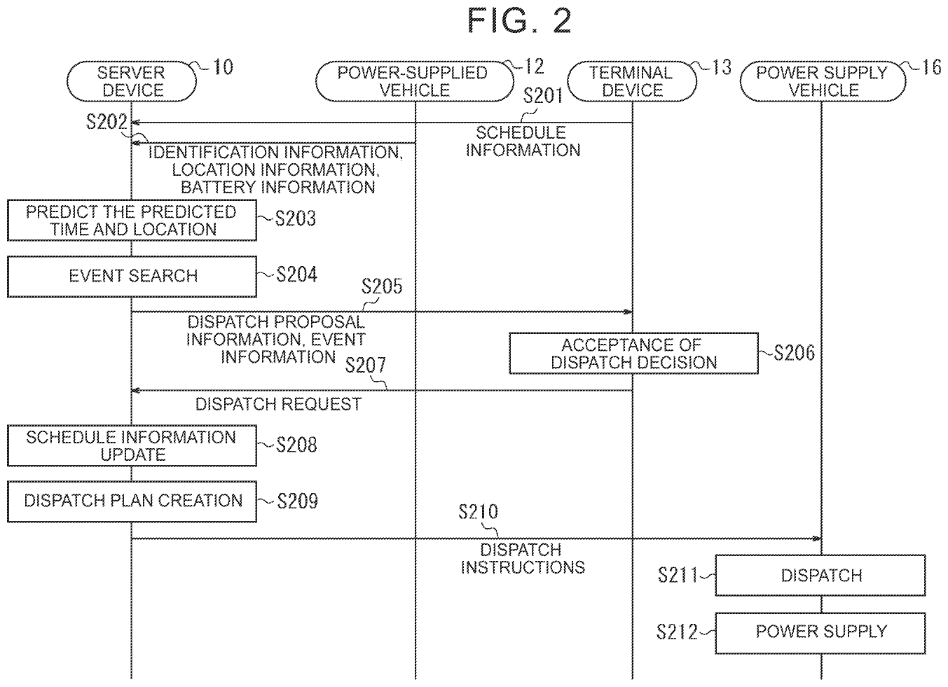

FIG. 2 is a sequence diagram illustrating an example of a procedure for the cooperative operation of the server device 10, the power-supplied vehicle 12, the terminal device 13, and the power supply vehicle 16. Steps related to various information processing of the server device 10, the power-supplied vehicle 12, the terminal device 13, and the power supply vehicle 16 in FIG. 2 are executed by the respective control units 103, 123, 133, and 123. In addition, the steps related to the transmission and reception of various information between the server device 10, the power-supplied vehicle 12, the terminal device 13, and the power supply vehicle 16 are carried out by the respective control units 103, 123, 133, and 123, respectively, by the communication units 101, 121, 131, and This is executed by sending and receiving information to and from each other via 121. In the server device 10, the power-supplied vehicle 12, the terminal device 13, and the power supply vehicle 16, the control units 103, 123, 133, and 123 appropriately store information to be processed, transmitted, and received in the storage units 102, 122, 132, and 122, respectively.

The procedure in FIG. 2 is an example of a procedure when the server device 10 dispatches the power supply vehicle 16 to charge the power-supplied vehicle 12.

In S201, the terminal device 13 sends schedule information to the server device 10. The schedule information includes the user's identification information and the user's travel schedule. The travel schedule includes the location and arrival time of the destination, the time spent at the destination, and the like. The terminal device 13 sends, for example, schedule information input by a user to an application program for schedule management to the server device 10 at an arbitrary frequency. The frequency of transmission of the schedule information is, for example, every few minutes to several hours, each time a schedule is input/updated, etc. Alternatively, the server device 10 may request the terminal device 13 to transmit schedule information at an arbitrary period, and the terminal device 13 may transmit the schedule information in response. The user can set the transmission frequency of schedule information in the terminal device 13 in advance.

In S202, the server device 10 acquires identification information, location information, and battery information from one or more power-supplied vehicles 12. The server device 10 requests information for each power-supplied vehicle 12 from one or more power-supplied vehicles 12, and acquires information sent from each power-supplied vehicle 12 in response to the request. The identification information includes information that specifies the power-supplied vehicle 12 and the user of the power-supplied vehicle 12. This identification information associates the user of the terminal device 13 with the power-supplied vehicle 12. Further, the identification information includes information such as the electric power required for traveling of the power-supplied vehicle 12 and the charging/discharging performance of the battery 15. The battery information includes information regarding the remaining amount of the battery 15. The remaining amount of the battery 15 is, for example, a State of Charge (SOC) value. S202 is executed at an arbitrary frequency, such as every few seconds to several tens of seconds, or every time S201 is executed.

When the server device 10 receives information from a plurality of power-supplied vehicles 12, it executes the steps from S203 onward for each power-supplied vehicle 12.

In S203, the server device 10 predicts a predicted time and a predicted point at which the power-supplied vehicle 12 will be in a power-out state. The server device 10 derives a travel route based on the user's travel schedule, and predicts the predicted time when the remaining battery level will become depleted based on the power consumed by the power-supplied vehicle 12 traveling on the travel route. The prediction point corresponding to the time is predicted. The server device 10 derives a travel route from the current position of the power-supplied vehicle 12 to a travel destination included in the travel schedule using an arbitrary algorithm. Furthermore, the server device 10 predicts the transition of the remaining battery capacity of the battery 15 on the travel route based on the electric power required for traveling of the power-supplied vehicle 12, the charging/discharging performance of the battery 15, and the distance of the travel route, and it is determined whether the power-supplied vehicle 12 will be in a power shortage state at the destination. The power shortage state is, for example, a state in which the SOC value of the battery 15 is below an arbitrary standard. An arbitrary standard is, for example, 20% to 30%. Any criteria may be set in advance by the user on the terminal device 13 and notified to the server device 10. When the power-supplied vehicle 12 is in a power outage state at the destination, the destination is predicted as a predicted point and the expected time of arrival is predicted as the predicted time. Alternatively, if the power-supplied vehicle 12 becomes out of power before reaching the destination, a point and time on the travel route at which the out-of-power condition is predicted are predicted as the predicted point and time.

In S204, the server device 10 searches for an event that will be held at the predicted time near the predicted point. The vicinity of the predicted point is an arbitrary distance range that includes the predicted point. The arbitrary distance is, for example, a distance from several hundred meters to several kilometers. The event to be carried out at the predicted time includes an event to be carried out several minutes to 10 minutes before or after the predicted time. The event may include an experiential attraction, a sale at a store, etc., as long as it continues for a certain period of time and allows the user to spend time there. Information on such events is obtained from a server or the like operated by an event management company or the like.

In S205, the server device 10 sends dispatch proposal information and event information to the user's terminal device 13. The dispatch proposal information is information for proposing dispatch of the power supply vehicle 16 to perform rush charging at the predicted time at the predicted point. The dispatch proposal information includes a predicted point and a predicted time, and may further include an SOC value predicted in a power outage state. The event information includes information on the type of event searched for, a summary of the event, and the location and time at which the event will be held.

In S206, the terminal device 13 accepts the user's dispatch decision. The terminal device 13 outputs the dispatch proposal information received from the server device 10 on a display or the like to prompt the user to decide on dispatch. Further, the terminal device 13 can also output the event information received from the server device 10 on a display or the like and present it to the user. Upon receiving the dispatch proposal information, the user can recognize the need for power supply at the predicted point and at the predicted time. Further, the user can recognize the type and outline of the event that will be held at the predicted time near the predicted point. By participating in the event during the time required for power supply, the user can make effective use of time. Therefore, the user can refer to the event information and decide whether to receive the dispatch of the power supply vehicle 16. When the user makes an input indicating a decision to dispatch in response to the dispatch proposal, the terminal device 13 receives this input. If the user chooses to participate in the event, the user inputs information indicating event participation and a dispatch decision into the terminal device 13.

In S207, the terminal device 13 sends a dispatch request to the server device 10. The dispatch request is a request for dispatching the power supply vehicle 16 to receive rush charging at the predicted time at the predicted point. If the user chooses to participate in the event, the predicted location is replaced by the location where the event will take place. Alternatively, if the dispatch has been rejected, the terminal device 13 may send information to the server device 10 that the power supply has been rejected.

The user of the terminal device 13 moves in the power-supplied vehicle 12 toward the destination of the present office or the point where the event will be held.

In S208, the server device 10 updates schedule information. If the destination is a predicted point and power supply at the predicted point is requested, the server device 10 adds information indicating that power supply will be performed at the predicted point at the predicted time to the schedule information. Alternatively, if a predicted point other than the destination, that is, a point where the event will be held, is the predicted point and power supply at the predicted point is requested, the server device 10 changes the destination to the point where the event is held, and information indicating that power supply will be executed at the predicted time at the predicted point is added to the schedule information.

In S209, the server device 10 creates a dispatch plan. The dispatch plan includes information such as identification of the power supply vehicle 16 that performs emergency charging, the travel route of the power supply vehicle 16, and the time at which the power supply vehicle 16 starts moving. The server device 10 acquires position information of one or more power supply vehicles 16 and information on the remaining battery power of the battery 15 in order to create a power supply plan. For example, the server device 10 requests one or more power supply vehicles 16 to transmit this information, and receives the information sent by the power supply vehicles 16 in response to the request. For example, the server device 10 selects, among the power supply vehicles 16 located within an arbitrary distance range (for example, several kilometers) from the predicted point, the power supply vehicle 16 with the largest remaining battery level as the power supply vehicle 16 that performs rush charging. Identify. Alternatively, the server device 10 selects the power supply vehicle 16 closest to the predicted point among the power supply vehicles 16 whose remaining battery level is equal to or higher than an arbitrary standard (for example, 60% in terms of SOC value) as the power supply vehicle 16 that performs rush charging. Identify. Then, the server device 10 uses an arbitrary algorithm to derive a travel route and a travel start time that will allow the identified power supply vehicle 16 to reach the predicted point by the predicted time.

In S210, the server device 10 sends a dispatch instruction to the specified power supply vehicle 16. The dispatch instruction includes information on the travel route to the predicted point and the travel start time.

In S211, the power supply vehicle 16 is dispatched in response to the dispatch instruction. The power supply vehicle 16 starts moving according to the moving route when the moving start time comes. Alternatively, the power-supplied vehicle 12 displays the travel route to the occupant, and starts moving in response to the occupant's operation.

When the power supply vehicle 16 arrives at the predicted point, power is supplied from the power supply vehicle 16 to the power-supplied vehicle 12 in S212. For example, the power supply vehicle 16 charges the battery 15 of the power-supplied vehicle 12 with power for power supply from the battery 15 through an operation by a passenger or an operation of an automatic machine.

While power is being supplied from the power supply vehicle 16 to the power-supplied vehicle 12, the user can participate in an event, for example, and can make effective use of his or her time.

By doing as described above, the user can avoid the trouble of considering the necessity of power supply every time he or she moves. At the same time, it becomes possible to effectively utilize the time during which power is supplied. Therefore, user convenience can be improved.

Although the embodiment has been described above based on the drawings and examples, it should be noted that those skilled in the art can easily make various modifications and alterations thereto based on the present disclosure. It should be noted, therefore, that these modifications and alterations are within the scope of the present disclosure. For example, the functions included in each means, each step, etc. can be rearranged so as not to be logically inconsistent, and a plurality of means, steps, etc. can be combined into one or divided.

What is claimed is:

1. A server device comprising:
a communication unit; and
a control unit that performs communication using the communication unit, wherein:
the control unit predicts, based on a movement schedule of a user and information on a remaining battery capacity of a vehicle of the user, a point and time at which the remaining battery capacity reaches a predetermined state; and
information proposing a dispatch of a power supply vehicle to the point at the time is transmitted to a terminal device of the user to prompt the user to decide on the dispatch.

2. The server device according to claim 1, wherein:
the control unit derives a movement route of the user based on the movement schedule; and
the control unit predicts, based on power consumed by the vehicle traveling on the movement route, the time at which the remaining battery capacity reaches the predetermined state and the point corresponding to the time.

3. The server device according to claim 1, wherein, when the control unit receives, from the terminal device, information that the dispatch of the power supply vehicle is decided, the control unit instructs the power supply vehicle to move to the point.

4. The server device according to claim 1, wherein the control unit further transmits information on an event that is held near the point at the time to the terminal device.

5. The server device according to claim 4, wherein, when the control unit receives, from the terminal device, information that the event is selected, the control unit instructs the power supply vehicle to move to a point where the event is held instead of the point.
